(19) United States
(12) Patent Application Publication
(10) Pub. No.: US 2007/0041871 A1
(43) Pub. Date: Feb. 22, 2007

(54) Gravimetric field titration kit and method of using thereof

(76) Inventor: Frank Lecrone, Spruce Creek, PA (US)

Correspondence Address: MCQUAIDE BLASKO, 811 UNIVERSITY DRIVE, STATE COLLEGE, PA, 16801, US

(21) Appl. No.: 11/505,124

(22) Filed: Aug. 16, 2006

Related U.S. Application Data
(60) Provisional application No. 60/708,811, filed on Aug. 16, 2005.

(51) Int. Cl. B01L 3/00

(52) U.S. Cl. 422/61

(57) ABSTRACT

A portable kit for performing gravimetric titrations in a variety of field settings, and a method for using thereof. Gravimetric titrations are much more precise than standard volumetric titrations performed in the field. The kit is completely self-contained inside of a durable case that allows the user to carry the kit with one arm into the field. Inside the case is a leveling device allowing the user to level the kit in the nonuniform environments typically found in the field. Once leveled, the user weighs the sample fluids and titrants on the digital weighing device placed inside the case. These readings are then used to determine certain properties of the test fluid using standard titration calculations.

### REFERENCE TO RELATED APPLICATIONS

This application claims benefit of U.S. Provisional Patent Application No. 60/708,811 filed Aug. 16, 2005.

### BACKGROUND OF THE INVENTION

1. Field of the Invention

The present invention relates to a method and a portable kit for performing gravimetric titration analyses in a field setting.

2. Background Art

Titration is a well known analytic method for determining the concentration of an unknown solute in a test solution as well as determining the characteristics of a particular fluid (e.g., the acidity of the fluid). Currently, volumetric titration is the predominant technology for analyzing solute/solvent constituents in fluids. Generally, the volumetric titration procedure involves the measured addition of a titrant into a test fluid that contains the unknown concentration of solute. Eventually, enough titrant is added to the test fluid to bring a particular chemical reaction to completion, also known as the reaction's “endpoint.” The endpoint can be determined by observing a change in color of an indicator that has been added to the test fluid. Phenolphthalein is one example of an indicator. The color change can be detected with the naked eye or by an electronic color detector. U.S. Pat. No. 5,192,509 discloses a titration apparatus comprising an optical detector to measure the endpoint.

When the titration reaction reaches its endpoint, the known quantity of expended titrant can be used to calculate the unknown concentration of the solute. In a laboratory, the volumetric titration procedure is carried out with precise instruments, such as a glass burette for measuring the volume of titrant added to the test fluid. In the field, the procedure is carried out with instruments that are much less precise than those used in the laboratory. The reasons for this include the need to carry the titration instruments into the field and the harsh, nonuniform environments typically found in the field that would damage and destroy sensitive laboratory equipment (such as equipment made of glass). Accordingly, practitioners working in the field use titration equipment that is both lightweight and durable. A prime example of such portable instrumentation would be a plastic drop bottle, instead of a glass burette, for adding a titrant to the test fluid.

Basic volumetric titration technologies involve certain drawbacks when performed outside of a laboratory with portable instruments. For instance, the drop-size, which is the basis for a “drop count” utilized to complete titrations, is non-standard and highly variable. Many factors, including the angle at which the bottle is held, the pressure applied to the bottle, and the wall thickness of bottles, tip fouling, tip distortions, titrant surface tension, titrant adhesive forces can vary the volume contained within a drop. Similarly, when the test fluid is poured or placed in a container, a visual reading is ordinarily made regarding the level of the fluid in the container. However, the meniscus at the top of the fluid in the container often creates optical distortion and difficulty in reading the precise volume in question. This can lead to a significant inaccuracy when calculating analyte concentrations. The current inaccuracy of drop-count volumetric titration kits ranges from 5 to 20%.

Gravimetric titrations are inherently more precise and more accurate than volumetric titrations. The advent of highly-precise and consistent digital scales has enabled scientists to achieve higher level accuracy in titration analyses than previously recognized. However, the development of an efficient and portable method and kit for gravimetric titrations in the field has been previously unrecognized and unreported.

An additional problem encountered in field titrations involves the recording of data. In the field, there is a need to hand-record data regarding drop count and fluid volumes. Later, the recorded data is manually entered into a computer for computation of test results. This manual process leads to inefficiencies and potential transcription errors in processing test data. Furthermore, some field titrations must be performed at night or in inadequate lighting, making it even more difficult to accurately record data.

In many instances, such inaccuracy is not acceptable. Accordingly, there is a need for an improved field titration technology that allows for increased accuracy over existing technologies. Additionally, there is a need for a titration technology that allows for rapid, efficient, and accurate transmission of field-titration data. Finally, there is a need for titration technology that is easily implementable in a variety of field settings.

### SUMMARY OF THE INVENTION

It is a primary object of the present invention to provide an easily portable kit and method for performing accurate gravimetric titrations in a variety of field settings. Test samples and titrant amounts gravimetrically measured between 0.01 to 0.001 g yield accuracies of 99+%. Such accuracy has previously been exceedingly difficult to achieve in the field. The kit is designed to improve the accuracy of titration readings taken in the field, as well as allow a user to easily obtain readings in a variety of outdoor conditions. The titration kit is preferably comprised of the following: a durable case with built-in leveling mechanism; adjustable legs attached to the case; vibration control pads; radiation protection; a digital weighing device capable of weighing samples with 0.001 g readability; a microprocessor located within said weighing device and programmed to perform certain specific titration calculations; an electronic data storage device installed in said weighing device; dropper bottles with fine tip dispensers; syringe with fine tip dispenser; sample collection and weighing containers; analytical reagent systems; a self-stirring device; a battery-powered light affixed to the case; and a USB port, FireWire port, or wireless communications adapter (e.g., a Wi-Fi card) installed in said weighing device.

### BRIEF DESCRIPTION OF THE DRAWINGS

FIG. 1 is a perspective view of a gravimetric field titration kit, with retractable legs attached to the base of the kit and capable of bringing the kit to waist level, according to a first embodiment of the invention;

FIG. 2 is a perspective view of the gravimetric field titration kit shown in FIG. 1 with adjustable feet attached to the base of the kit, according to a second embodiment of the invention.

### DETAILED DESCRIPTION OF THE INVENTION

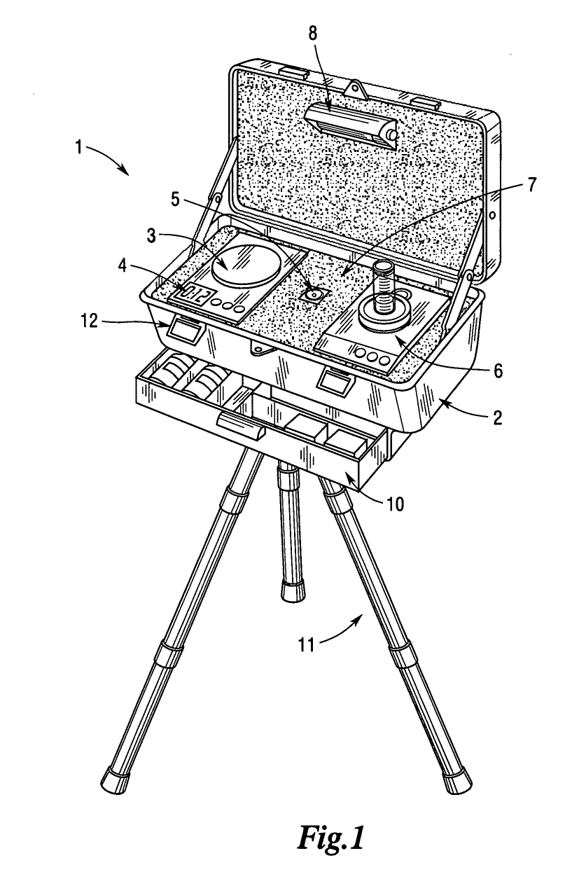

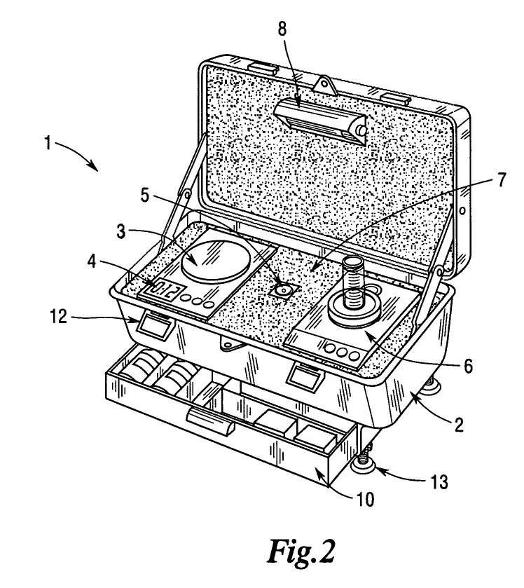

The present invention overcomes the disadvantages of the prior art by providing a portable gravimetric titration kit containing all necessary apparatus, equipment and reagents to conduct highly precise field titrations with an accuracy equaling that of laboratory titrations. Referring to FIGS. 1-2, all of the necessary items for the titration kit 1 are contained in a hinged case 2. The case 2 may be carried by a handle. The case 2 is preferably constructed of a heavy-duty, impact-proof, water-proof, and dust-proof material, such as heavy plastic or aluminum. In one embodiment of the invention, the case 2 is constructed of a material capable of protecting the contents inside the case 2 from high levels of radiation. The case 2 includes a latching mechanism 12 that allows for the case 2 to be locked when in the closed position. A leveling means 5, such as a spirit level or bubble level, is positioned inside the case 2 in such a way that allows the user to confirm the titration kit 1 is balanced when placed on an uneven surface. This allows the user to place the titration kit 1 on a non-level surface, such as a rocky stream bed or a motor vehicle, and still achieve a level surface for performing titrations. Although not necessary to the claimed invention, one preferred embodiment of the titration kit 1 includes at least three (3) separately adjustable legs 11, as shown in FIG. 1, that attach to the base of the case 2. Alternatively, as shown in FIG. 2, at least three (3) adjustable feet 13 are attached to the base of the case 2. The legs 11 and feet 13 can be adjusted upwards or downwards to level the kit 1 on uneven ground and for the convenience of the user. A battery-powered light 8 is preferably affixed to the inside of the case 2 in such a way that allows for titration readings to be taken at night or in low light conditions. The preferred light 8 is a white LED, but any instrument capable of illuminating the titration kit 1 can be used. Preferably, the case 2 also includes an opening to allow cables, such as RS232 or USB cables, to enter the case 2 and connect with the devices inside the case 2.

Within the case 2, the titration kit 1 includes a digital weighing device 3 to perform precise gravimetric measurements. The weighing device 3 includes a display 4 capable of displaying at least one numerical digit. The weighing device 3 is used to weigh test samples and titrant amounts. Preferably, the weighing device 3 is a handheld weighing device and has a readability of at least 0.001 g. While the weighing device 3 can be any digital weighing device commercially available with at least a 0.01 g readability, the preferred models for the titration kit 1 include the My Weigh iBAL 201® and the Ohaus Scout®. Preferably, the weighing device 3 sits inside a vibration control pad 7. The vibration control pad 7 is shaped to fit inside the case 2. The vibration control pad 7 is preferably made of polyurethane foam, although any industrial strength foam can be used.

In the preferred embodiment, a microprocessor capable of performing calculations, such as the microprocessor disclosed in U.S. Pat. No. 3,757,306, is installed inside the weighing device 3. The readings taken by the weighing device 3 are processed by the microprocessor according to which property the user desires to test. Such properties may include: acidity, alkalinity, carbon dioxide concentration, chlorine levels, dissolved oxygen levels, total hardness, calcium hardness, nitrate concentration, and salinity levels. These properties are calculated by the microprocessor according to stoichiometric equations that are well known to persons of ordinary skill in the art and have been initially programmed into the microprocessor. One example of such an equation calculated by the customized weighing device 3 is as follows:

$$( \frac{{G}_{1}}{{G}_{2}} ) \times ( 1000 \times {N}_{1} \times {EW}_{2} \times ( \frac{{D}_{2}}{{D}_{1}} ) ) = Rt$$

G₁=weight of titrant
G₂=weight of sample
N₁=normality of titrant
EW₂=equivalent weight of analyte
D₁=density of titrant
D₂=density of sample
Rt=test result

In the preferred embodiment of the titration kit 1, the weighing device 3 includes a series of function buttons that can be pre-programmed to correspond to particular stoichiometric equations. When the user wishes to determine a certain property of the test sample, he simply pushes the button that activates the customized weighing device 3 to process that calculation and display the result in the weighing device's digital display 4.

Preferably, the results are also stored in a data storage device that is installed inside the weighing device 3. The data storage device can be any device typically used to permanently store electronic data, such as a Flash memory card. In an alternative embodiment, a USB port or RS232 port is attached to the weighing device 3 to allow the transmission of data from the weighing device 3 to a personal computer or other data-receiving device. In a further embodiment of the titration kit 1, a wireless communications adapter, such as the device disclosed in U.S. Pat. No. 6,873,611, is installed inside the weighing device 3 to allow for wireless transmission of test data.

In the preferred embodiment, the titration kit 1 includes a self-stirring device 6. Preferably, the self-stirring device 6 is located in the case 2 next to the weighing device 3. The self-stirring device 3 can be any commercially available magnetic stirrer, such as the Vernier Stir Station®.

The titration kit 1 includes chemical titrants, indicators, and related chemicals for performing a variety of titrations in the field. The titrants and indicators can be any chemical generally used in the art to perform analytic titrations. Titrant examples include: sodium hydroxide, acetic acid, and hydrochloric acid. Indicator examples include: phenolphthalein, methyl orange and phenol red. Sturdy, plastic sample vials and dropper bottles or dispensing syringes are used to store the titrants and indicators as well as add them to the test fluid. The plastic containers take the place of expensive, fragile volumetric glassware and burettes that can be easily damaged in harsh field environments. Preferably, the titrants, indicators and equipment typically used in the art to perform titrations are stored in a customized drawer 10 located in the front of the case 2. The drawer 10 pulls outwards from the case 2 to allow for easy storage and access to the selected materials required for gravimetric titrations.

What is claimed is:

1. A gravimetric field titration kit comprising:
(a) a hinged case with a latching mechanism;
(b) a digital weighing device placed inside said case, having a readability of at least 0.01 gm and having a screen capable of displaying at least one numerical digit;
(c) a leveling means attached to said case that provides a level reading relative to the surface of said digital weighing device;
(d) at least one (1) chemical reagent that can be used to perform a titration reaction; and
(e) a means of collecting a sample fluid.

2. The kit of claim 1 wherein said case is comprised of a plastic material.

3. The kit of claim 1 wherein said case is comprised of a metallic material.

4. The kit of claim 1 wherein said case is comprised of a radiation-proof material.

5. The kit of claim 1 wherein said digital weighing device includes a microprocessor capable of performing at least one (1) titration calculation.

6. The kit of claim 5 wherein said microprocessor is programmed to perform at least one (1) titration calculation.

7. The kit of claim 6 wherein said weighing device includes a least one (1) exterior function button that is programmed to direct said microprocessor to perform a titration calculation.

8. The kit of claim 5 wherein said weighing device includes a data storage device.

9. The kit of claim 1 further comprising a vibration control pad.

10. The kit of claim 1 wherein said chemical reagent is stored in a container made of a plastic material.

11. The kit of claim 1 wherein said case includes at least one (1) drawer.

12. The kit of claim 1 further comprising at least three (3) legs attached to the base of said case.

13. The kit of claim 12 wherein said legs are adjustable.

14. The kit of claim 1 further comprising at least three (3) feet attached to the base of said case.

15. The kit of claim 14 wherein said feet are adjustable.

16. The kit of claim 1 wherein said balancing means is comprised of a bubble balance.

17. The kit of claim 1 further comprising a self-stirring device.

18. The kit of claim 17 wherein said self-stirring device is a magnetic stirrer.

19. The kit of claim 1 wherein said weighing device includes a USB port.

20. The kit of claim 1 wherein said weighing device includes a RS232 port.

21. The kit of claim 1 wherein said weighing device includes a wireless transmission means.

22. The kit of claim 1 further comprising a light attached to said case.

23. The kit of claim 22 wherein said light is an LED.

24. A method for conducting gravimetric titrations in the field, the method comprising:
(a) transporting a gravimetric field titration kit to the test site;
(b) balancing said gravimetric field titration kit so that it remains in a level position;
(c) collecting a sample fluid to be analyzed;
(d) placing the sample fluid on the weighing device located in said gravimetric field titration kit;
(e) weighing the sample fluid with said weighing device;
(f) performing titration reaction with a reagent included in said gravimetric field titration kit;
(g) weighing said reagent after completion of said titration reaction;
(h) calculating desired property of said sample fluid using a titration equation.

25. The method of claim 24 further comprising the step of illuminating said gravimetric field kit with a battery-powered light.

26. The method of claim 24 further comprising the step of adjusting the feet or legs attached to the base of said gravimetric field titration kit.

27. The method of claim 24 further comprising the step of stirring said sample fluid.

28. The method of claim 24 wherein the step of calculating said desired property includes the step of pressing the button on said weighing device that corresponds to said desired property.

29. The method of claim 24 further comprising the step of electronically storing the test results.

30. The method of claim 29 further comprising the step of electronically transmitting the test results to a data-receiving device.
